(19) United States
(12) Patent Application Publication
(10) Pub. No.: US 2023/0049062 A1
(43) Pub. Date: Feb. 16, 2023

(54) HIGH VOLTAGE ELECTRICAL CONNECTOR WITH CLAD CONTACT BUTTON AND METHOD OF MANUFACTURING SAME

(71) Applicant: Aptiv Technologies Limited, St. Michael (BB)

(72) Inventors: Nicholas A. Durse, Youngstown, OH (US); George A. Drew, Warren, OH (US); Eric E. Shasteen, Salem, OH (US)

(21) Appl. No.: 17/884,886

(22) Filed: Aug. 10, 2022

Related U.S. Application Data
(60) Provisional application No. 63/233,382, filed on Aug. 16, 2021.

(51) Int. Cl. H01R 4/28; H01R 25/14; H01R 13/22; H01R 13/15; H01R 4/02

(52) U.S. Cl. CPC H01R 4/28; H01R 25/14; H01R 13/22; H01R 13/15; H01R 4/02; H01R 2201/26

(57) ABSTRACT

An electrical connector includes a contact button having a first layer formed of a first electrically conductive material that is attached to a first electrical bus bar and having a second layer formed of a second electrically conductive material clad to the first layer. The electrical connector includes a clamp assembly including a retaining band surrounding the contact button and the first electrical bus bar and having a spring configured to provide a contact force between the contact button and a second electrical bus bar when the second electrical bus bar is disposed between the contact button and the spring.

### CROSS-REFERENCE TO RELATED APPLICATION

This application claims benefit of priority to U.S. Application No. 63/233,382 filed on Aug. 16, 2021, the entire disclosure of which is hereby incorporated by reference.

### TECHNICAL FIELD OF THE INVENTION

This disclosure is directed to a high voltage electrical connector and more particularly to a high voltage electrical connector with a clad contact button.

### BACKGROUND

Prior high voltage terminal interfaces have included a ribbed contact surface to provide a concentrated contact point between the electrical terminals. In some applications, this contact surface is embossed into the terminal and abruptly rises into the path of the mating terminal as the connection system is being connected.

### SUMMARY

Contact buttons have been used in switching contact applications, such as relays or contactors that conduct high voltages and/or high currents. However, these contact buttons have not been used for sliding contact interfaces such as is common in pluggable, automotive electrical connectors.

According to one or more aspects of the present disclosure, an electrical connector includes a contact button having a first layer formed of a first electrically conductive material that is attached to a first electrical bus bar and having a second layer formed of a second electrically conductive material clad to the first layer and a clamp assembly including a retaining band surrounding the contact button and the first electrical bus bar and having a spring configured to provide a contact force between the contact button and a second electrical bus bar when the second electrical bus bar is disposed between the contact button and the spring.

In one or more embodiments of the electrical connector according to any one of the previous paragraphs, an outer surface of the second layer defines a plurality of protrusions.

In one or more embodiments of the electrical connector according to any one of the previous paragraphs, the plurality of protrusions is in the form of a plurality of spherical sections.

In one or more embodiments of the electrical connector according to any one of the previous paragraphs, the contact button has a generally cylindrical shape.

In one or more embodiments of the electrical connector according to any one of the previous paragraphs, an edge of the second layer is chamfered.

In one or more embodiments of the electrical connector according to any one of the previous paragraphs, a circumferential edge of the second layer is chamfered.

In one or more embodiments of the electrical connector according to any one of the previous paragraphs, the second electrically conductive material is selected from a list consisting of fine silver, a silver-copper alloy, a silver-tin oxide composite material, a silver-carbon composite material, a silver-nickel composite, or a silver-cadmium oxide composite material.

In one or more embodiments of the electrical connector according to any one of the previous paragraphs, the electrical connector includes a plurality of contact buttons.

In one or more embodiments of the electrical connector according to any one of the previous paragraphs, the plurality of contact buttons is arranged in a triangular pattern.

In one or more embodiments of the electrical connector according to any one of the previous paragraphs, the first bus bar is formed of parallel first and second layers of electrically conductive material mechanically and electrically joined. Ends of the first and second layers of the first bus bar are separated so that the second electrical bus bar may be received between them.

In one or more embodiments of the electrical connector according to any one of the previous paragraphs, the first and second layers of the first bus bar are symmetrical about a joint between them.

According to one or more aspects of the present disclosure, a method of forming an electrical connector configured to interconnect two electrical bus bars includes the steps of attaching a contact button to a first electrical bus bar, the contact button having a first layer formed of a first electrically conductive material and a second layer formed of a second electrically conductive material clad to the first layer and attaching a clamp assembly including a retaining band to the first electrical bus bar such that the clamp assembly surrounds the contact button and the first electrical bus bar. The clamp assembly has a spring configured to provide a contact force between the contact button and a second electrical bus bar when a second electrical bus bar is disposed between the contact button and the spring.

In one or more embodiments of the method according to the previous paragraph, the contact button is attached to the first electrical bus bar by a process selected from brazing, soldering, resistance welding, laser welding, and spin welding.

In one or more embodiments of the method according to any one of the previous paragraphs, an outer surface of the second layer defines a plurality of protrusions.

In one or more embodiments of the method according to any one of the previous paragraphs, the plurality of protrusions is in the form of a plurality of spherical sections.

In one or more embodiments of the method according to any one of the previous paragraphs, the contact button has a generally cylindrical shape.

In one or more embodiments of the method according to any one of the previous paragraphs, an edge of the second layer is chamfered.

In one or more embodiments of the method according to any one of the previous paragraphs, a circumferential edge of the second layer is chamfered.

In one or more embodiments of the method according to any one of the previous paragraphs, the method further includes the step of attaching a plurality of contact buttons to the first electrical bus bar.

In one or more embodiments of the method according to any one of the previous paragraphs, the method further includes the step of arranging the plurality of contact buttons in a triangular pattern.

In one or more embodiments of the method according to any one of the previous paragraphs, the first bus bar is formed of parallel first and second layers of electrically conductive material mechanically and electrically joined. Ends of the first and second layers of the first bus bar are separated so that the second electrical bus bar may be received between them. The method further includes inserting the second electrical bus bar between the ends of the first and second layers of the first bus bar.

In one or more embodiments of the method according to any one of the previous paragraphs, the first and second layers of the first bus bar are symmetrical about a joint between them.

### BRIEF DESCRIPTION OF THE DRAWINGS

The present invention will now be described, by way of example with reference to the accompanying drawings, in which:

FIGS. 1A and 1B are perspective views of an electrical connector configured to interconnect electrical bus bars according to according to some embodiments;

FIG. 2A is an exploded view of a contact button of the electrical connector of FIGS. 1A and 1B having two layers according to according to some embodiments;

FIG. 2B is an exploded view of a contact button of the electrical connector of FIGS. 1A and 1B having three layers according to according to some embodiments;

FIG. 3 is a perspective subassembly view of the electrical connector of FIGS. 1A and 1B showing a clamp assembly according to some embodiments;

FIG. 4 is a perspective view of the electrical connector of FIGS. 1A and 1B and a corresponding second electrical bus bar configured to be received within the electrical connector according to some embodiments;

FIG. 5 is a perspective assembly view of second bus bar shown in FIG. 3 received within the electrical connector of FIGS. 1A and 1B according to some embodiments;

FIG. 6 is a perspective subassembly view of the electrical connector of FIGS. 1A and 1B showing a contact button attached to an electrical bus bar according to some embodiments;

FIG. 7 is a perspective subassembly view of the electrical connector of FIGS. 1A and 1B showing alternative contact button designs according to some embodiments;

FIG. 8 is a perspective subassembly view of an electrical connector showing alternative contact button arrangements according to some embodiments;

FIG. 9A is an exploded top view of an electrical connector having a split end according to some embodiments;

FIG. 9B is an exploded bottom view of an electrical connector having a split end according to some embodiments;

FIG. 10A is an exploded top view of an electrical connector having a split end according to some other embodiments;

FIG. 10B is an exploded bottom view of an electrical connector having a split end according to some other embodiments;

FIG. 11A is an exploded top view of an electrical connector having a split end according to yet some other embodiments;

FIG. 11B is an exploded bottom view of an electrical connector having a split end according to yet some other embodiments; and

FIG. 12 is a flow chart of a method of forming an electrical connector configured to interconnect two electrical bus bars according to some embodiments.

### DETAILED DESCRIPTION

This disclosure is directed to an electrical connector suited for use in a high voltage application (e.g., over 200 volts) and particularly to an electrical connector having cladded electrical contact points. The current carried by such an electrical connector may typically range from 100 to 1000 amperes.

An electrical connector configured to interconnect two or more electrical bus bars or flat blade terminals and suited for use in high voltage applications is presented herein.

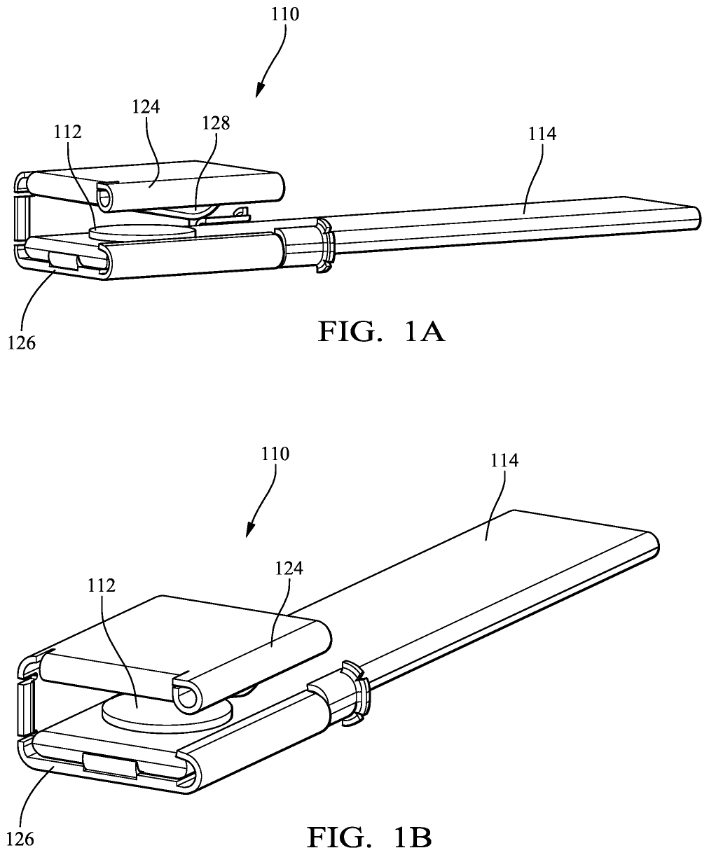

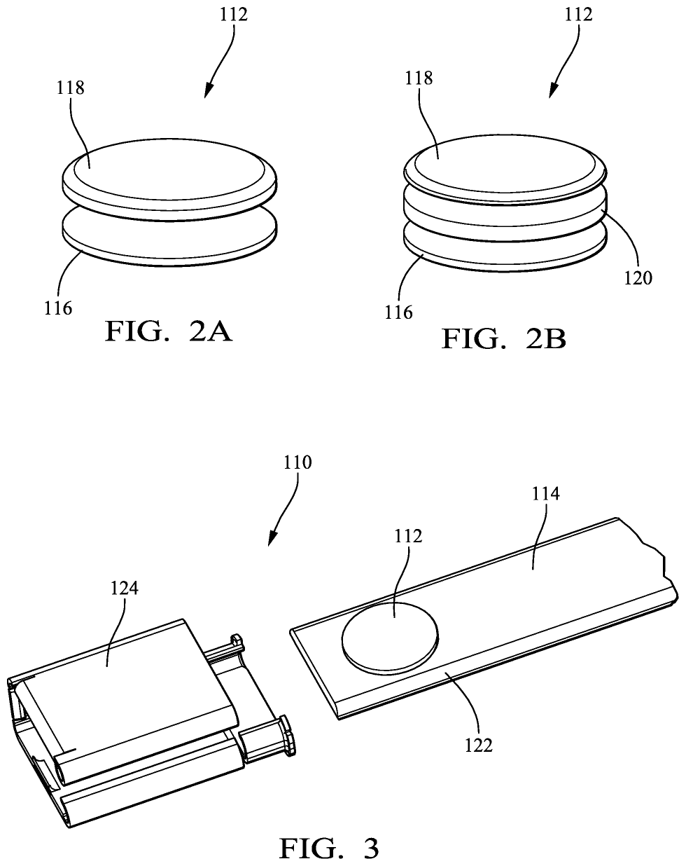

As shown, in FIGS. 1A and 1B, the electrical connector 110 includes a contact button 112 that is attached to a first electrical bus bar 114 formed of an electrically conductive material, such as a copper-based or aluminum-based material. The contact button 112 may be attached to the first bus bar 114 by brazing, soldering, resistance welding, laser welding, spin welding or any other suitable process. The contact button 112 has a bottom layer 116 that is attached directly to the first bus bar 114. As illustrated in FIG. 2A, this bottom layer 116 is formed of a first electrically conductive material, such as copper or aluminum. The bottom layer 116 may also include a flux material applied over the surface that is to be attached to the first bus bar 114 when using a brazing or welding process. The contact button 112 also has a top layer 118 that is formed of a second electrically conductive material and is clad to the bottom layer 116. As illustrated in FIG. 2B, the contact button 112 may also have another intermediate layer 120 between the bottom and top layers 116, 118 that is formed of a third electrically conductive material, e.g., a nickel-based alloy, a steel alloy, a MONEL® alloy, or a nickel-plated steel alloy. When the contact button 112 includes this intermediate layer 120, the bottom and top layers 116, 118 are clad to the intermediate layer 120. The second electrically conductive material is typically different from the first electrically conductive material and preferably has a lower electrical resistance than the first electrically conductive material. The second electrically conductive material may be a fine silver, i.e., a silver alloy having 99.9% by weight, a silver-copper alloy, a silver-tin oxide composite material, a silver-carbon composite material, a silver-nickel composite, or a silver-cadmium oxide composite material. Contact buttons of this type are available from Umicore Electrical Material USA Inc. of Glen Falls, N.Y. As shown in FIGS. 3 and 6, the first bus bar 114 may include a countersunk area 122 or a similar feature to help locate the contact button 112 on the first bus bar 114.

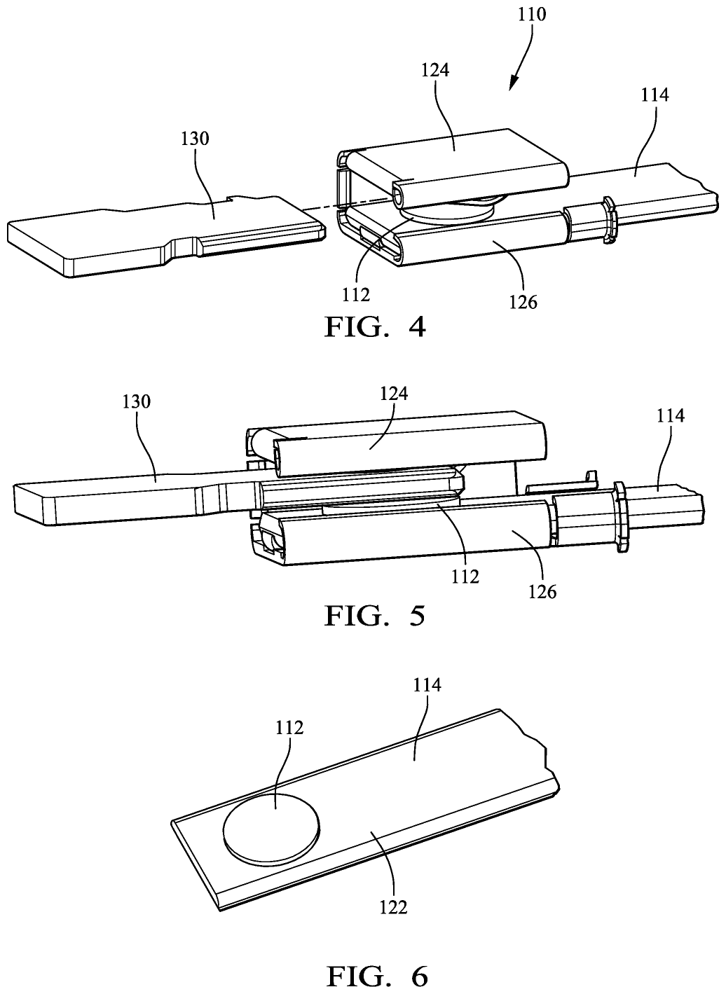

The electrical connector 110 also includes a clamp assembly 124 having a retaining band 126 that surrounds the contact button 112 and the first bus bar 114. The clamp assembly 124 also has a spring 128 that is configured to provide a contact force between the contact button 112 and a second electrical bus bar 130 or male blade terminal, shown in FIG. 4, when the second bus bar 130 or terminal is disposed between the contact button 112 and the spring 128, as shown in FIG. 5. Returning to FIG. 1A, the spring 128 is a cantilevered plate having an arcuate shape that is integrally formed with the retaining band 126. The clamp assembly 124 may be formed of a stainless-steel alloy, such as SAE 301 ½ hard stainless-steel. In alternative embodiments, other spring shapes or materials may be employed to provide the clamping force. It is appreciated that in an alternative embodiment the contact button 112 could be attached to the second electrical bus bar 130.

The contact button 112 has a generally flat cylindrical shape and the outer edges of the top layer 118 are chamfered as can be seen in FIG. 6, preferably by a coining process, in order to reduce edges that could increase the mating force when the second bus bar 130 is placed between the spring 128 and the contact button 112.

The alloy forming the top layer 118 is selected to withstand at least fifty or more mating/unmating cycles between the first and second bus bars 114, 130. Because the top layer 118 is clad to the contact button 112, the thickness of the top layer 118 can be made thicker more economically than providing a plated layer of similar thickness on the contact surface of a bus bar. A silver-graphene alloy or other silver-carbon composites having graphene, graphite, or other small carbon particles may be deposited on a surface of the contact button 112 to further increase durability of the electrical connector, thereby providing an increased number of successful mating/unmating cycles.

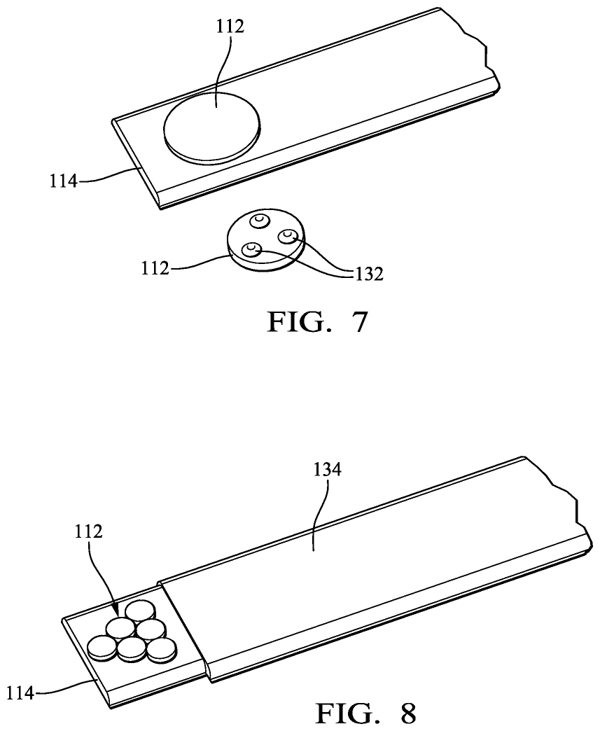

As illustrated in FIG. 7, alternative embodiments of the contact button 112 may include a number of contact protrusions in the form of spherical bumps 132. The bumps 132 provide smaller, more precise geometry than can be formed in thicker bus bars or terminals. This allows for more points of contact in a given area which makes for a more robust interface in a single contact button.

In an alternative embodiment shown in FIG. 8, a number of separate contacts buttons 112 may be arranged and attached to the first bus bar 114 in order to provide more points of contact in a given area. The contact buttons 112 may be arranged in a triangular shape to minimize the contact force needed to mate the second bus bar 130 with the electrical connector 110. The first bus bar 114 may also include an insulation layer 134 surrounding a portion of the first bus bar 114.

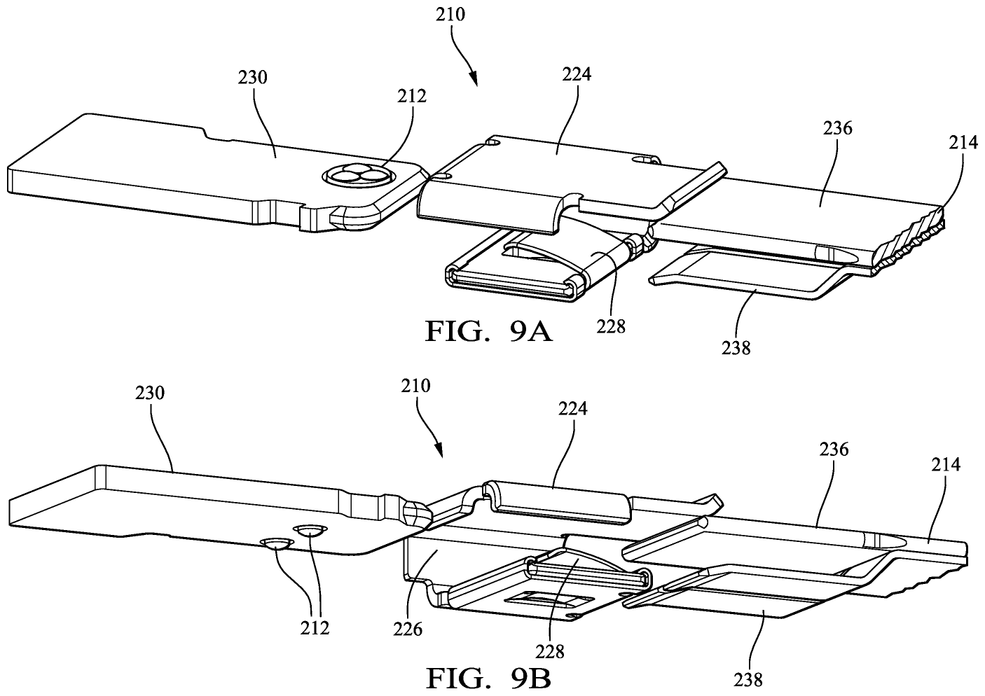

In a different alternative embodiment shown in FIGS. 9A and 9B, the electrical connector 210 includes a first bus bar 214 that is formed of parallel first and second layers 236, 238 of electrically conductive material. The first and second layers 236, 238 are mechanically and electrically joined, for example by welding, riveting, use of a clinch pin, etc. Ends of the first and second layers 236, 238 are separated so that a second electrical bus bar 230 may be received between them. A contact button 212 is attached to the second layer 238 of the first bus bar 214, which in this embodiment is thicker than the first layer 236 of the first bus bar 214. The electrical connector 210 also includes a clamp assembly 224 having a retaining band 226 that surrounds the contact buttons 212 and the first bus bar 214. The clamp assembly 224 also has a spring 228 that is configured to provide a contact force between the contact button 212 on the first bus bar 214 and the second electrical bus bar 230 by pressing against the first bus bar 214 which then presses the contact button 212 against the second bus bar 230.

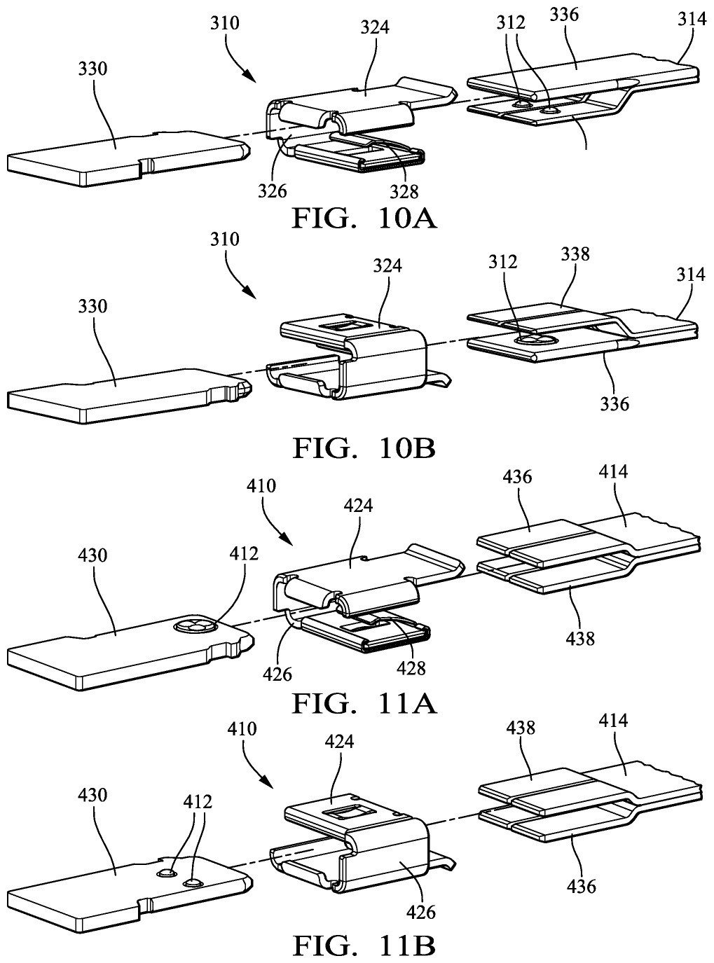

Another alternative embodiment of an electrical connector 310 is shown in FIGS. 10A and 10B. The electrical connector 310 is similar to the electrical connector 210 shown in FIG. 9, with a primary difference being the contact button 312 is attached to the second electrical bus bar 330 rather than to the second layer 338 of the first bus bar 314. The electrical connector 310 also includes a clamp assembly 324 having a retaining band 326 that surrounds the contact buttons 312 and the first bus bar 314. The clamp assembly 324 also has a spring 328 that is configured to provide a contact force between the contact button 312 on the second bus bar 330 and the first bus bar 314.

Yet another alternative embodiment of an electrical connector 410 is shown in FIGS. 11A and 11B. The electrical connector 410 is similar to the electrical connector 210 shown in FIG. 9, with a primary difference being the parallel first and second layers 436, 438 of the first bus bar 414 have the same thickness and are symmetrically arranged in relation to a joint 440 between them. Contact buttons 412 are attached to the upper and lower surfaces the second bus bar 430. The electrical connector 410 also includes a clamp assembly 424 having a retaining band 426 that surrounds the contact button 412 and the first bus bar 414. The clamp assembly 424 also has a spring 428 that is configured to provide a contact force between the contact button 412 on the first bus bar 414 and the second bus bar 430 by pressing against the first bus bar 414 which then presses the contact button 412 against the second bus bar 430.

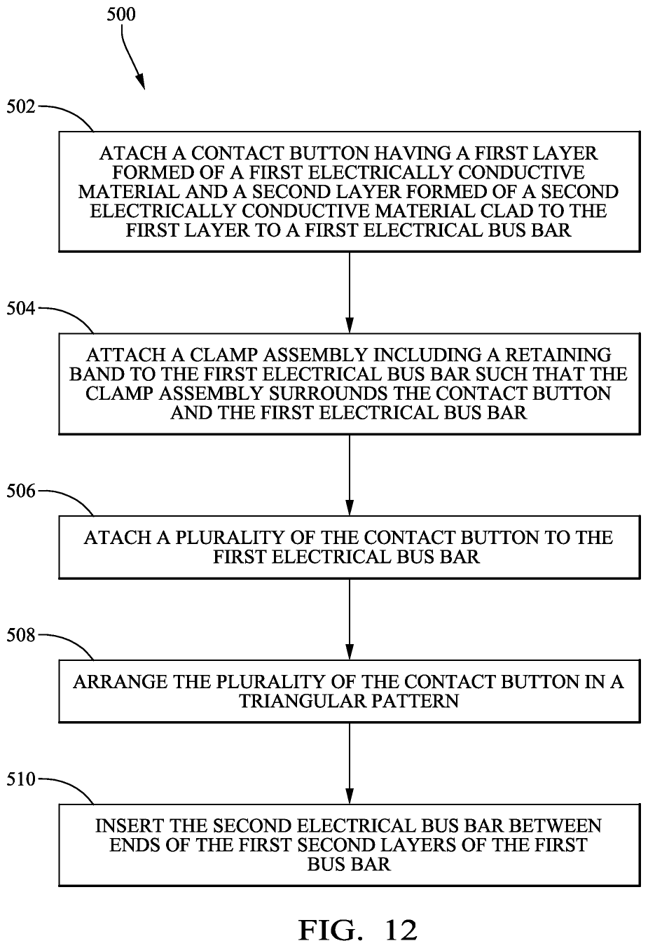

FIG. 12 shows a flow chart of a method 500 of forming an electrical connector configured to interconnect two electrical bus bars. The method includes the following steps:

STEP 502, ATTACH A CONTACT BUTTON HAVING A FIRST LAYER FORMED OF A FIRST ELECTRICALLY CONDUCTIVE MATERIAL AND A SECOND LAYER FORMED OF A SECOND ELECTRICALLY CONDUCTIVE MATERIAL CLAD TO THE FIRST LAYER TO A FIRST ELECTRICAL BUS BAR, includes attaching a contact button 112 having a first (bottom) layer 116 formed of a first electrically conductive material and a second (top) layer 118 formed of a second electrically conductive material clad to the first (bottom) layer 116 to a first electrical bus bar 114;

STEP 504, ATTACH A CLAMP ASSEMBLY INCLUDING A RETAINING BAND TO THE FIRST ELECTRICAL BUS BAR SUCH THAT THE CLAMP ASSEMBLY SURROUNDS THE CONTACT BUTTON AND THE FIRST ELECTRICAL BUS BAR, includes attaching a clamp assembly 124 including a retaining band 126 to the first electrical bus bar 114 such that the clamp assembly 124 surrounds the contact button 112 and the first electrical bus bar 114;

STEP 506, ATTACH A PLURALITY OF CONTACT BUTTONS TO THE FIRST ELECTRICAL BUS BAR, includes attaching a plurality of contact buttons 112 to the first electrical bus bar 114, see FIG. 8; and

STEP 508, ARRANGE THE PLURALITY OF CONTACT BUTTONS IN A TRIANGULAR PATTERN, includes arranging the plurality of contact buttons in a triangular pattern, see FIG. 8.

STEP 510, INSERT THE SECOND ELECTRICAL BUS BAR BETWEEN THE ENDS OF THE FIRST AND SECOND LAYERS OF THE FIRST BUS BAR, includes inserting the second electrical bus bar 230, 330 between the ends of the first and second layers 236, 238, 336, 338 of the first bus bar 214, 314, see FIGS. 9-11.

While this invention has been described in terms of the preferred embodiments thereof, it is not intended to be so limited, but rather only to the extent set forth in the claims that follow. For example, the above-described embodiments (and/or aspects thereof) may be used in combination with each other. In addition, many modifications may be made to configure a particular situation or material to the teachings of the invention without departing from its scope. Dimensions, types of materials, orientations of the various components, and the number and positions of the various components described herein are intended to define parameters of certain embodiments and are by no means limiting and are merely prototypical embodiments.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order of operations, direction, or orientation unless stated otherwise.

1. An electrical connector, comprising:
a contact button having a first layer formed of a first electrically conductive material that is attached to a first electrical bus bar and having a second layer formed of a second electrically conductive material clad to the first layer; and
a clamp assembly including a retaining band surrounding the contact button and the first electrical bus bar and having a spring configured to provide a contact force between the contact button and a second electrical bus bar when the second electrical bus bar is disposed between the contact button and the spring.

2. The electrical connector according to claim 1, wherein an outer surface of the second layer defines a plurality of protrusions.

3. The electrical connector according to claim 2, wherein the plurality of protrusions is in the form of a plurality of spherical sections.

4. The electrical connector according to claim 1, wherein the contact button has a generally cylindrical shape.

5. The electrical connector according to claim 4, wherein an edge of the second layer is chamfered.

6. The electrical connector according to claim 1, wherein the second electrically conductive material is selected from a list consisting of fine silver, a silver-copper alloy, a silver-tin oxide composite material, a silver-carbon composite material, a silver-nickel composite, and a silver-cadmium oxide composite material.

7. The electrical connector according to claim 1, comprising a plurality of contact buttons.

8. The electrical connector according to claim 7, wherein the plurality of contact buttons is arranged in a triangular pattern.

9. The electrical connector according to claim 1, wherein the first bus bar is formed of parallel first and second layers of electrically conductive material mechanically and electrically joined, and wherein ends of the first and second layers of the first bus bar are separated so that the second electrical bus bar may be received between them.

10. The electrical connector according to claim 9, wherein the first and second layers of the first bus bar are symmetrical about a joint between them.

11. A method of forming an electrical connector configured to interconnect two electrical bus bars, comprising:
attaching a contact button to a first electrical bus bar, the contact button having a first layer formed of a first electrically conductive material and a second layer formed of a second electrically conductive material clad to the first layer; and
attaching a clamp assembly including a retaining band to the first electrical bus bar such that the clamp assembly surrounds the contact button and the first electrical bus bar, wherein the clamp assembly has a spring configured to provide a contact force between the contact button and a second electrical bus bar when a second electrical bus bar is disposed between the contact button and the spring.

12. The method according to claim 11, wherein the contact button is attached to the first electrical bus bar by a process selected from brazing, soldering, resistance welding, laser welding, and spin welding.

13. The method according to claim 11, wherein an outer surface of the second layer defines a plurality of protrusions.

14. The method according to claim 13, wherein the plurality of protrusions is in the form of a plurality of spherical sections.

15. The method according to claim 11, wherein the contact button has a generally cylindrical shape.

16. The method according to claim 15, wherein an edge of the second layer is chamfered.

17. The method according to claim 11, further comprising attaching a plurality of contact buttons to the first electrical bus bar.

18. The method according to claim 17, further comprising arranging the plurality of contact buttons in a triangular pattern.

19. The method according to claim 11, wherein the first bus bar is formed of parallel first and second layers of electrically conductive material mechanically and electrically joined, wherein ends of the first and second layers of the first bus bar are separated, and wherein the method further includes inserting the second electrical bus bar between the ends of the first and second layers of the first bus bar.

20. The method according to claim 19, wherein the first and second layers of the first bus bar are symmetrical about a joint between them.
